(19) United States
(12) Patent Application Publication
(10) Pub. No.: US 2004/0089677 A1
(43) Pub. Date: May 13, 2004

(54) Particle dispenser

(76) Inventor: Gilbert Schwartzman, Mamaroneck, NY (US)

Correspondence Address: Clyde I. Coughenour, 16607 Sutton Place, Woodbridge, VA, 22191, US

(21) Appl. No.: 10/288,899

(22) Filed: Nov. 7, 2002

(51) Int. Cl. B67D 3/00

(52) U.S. Cl. 222/548

(57) ABSTRACT

Particles are discharged from a dispenser by pressing on a non-rotatable plunger attached to a helical spring. The linear motion of the plunger on the upper portion of the helical spring is converted to a rotary motion at the lower portion of the helical spring that is attached to an apertured plate. Rotation of the apertured plate causes openings in the dispenser base to aline with apertures in the plate to discharge particles. The amount of rotation of the plate and discharge can be adjusted.

### BACKGROUND OF THE INVENTION

1. Field of the Invention

A helical spring in a container has one end vertically pressed to cause the other end to horizontally rotate an apertured plate to dispense powder through passages that aline in an adjacent lower closure wall.

2. Description of Related Art

The dispensing of powders through alinement of apertured relative reciprocating and rotary members is common. U.S. Pat. No. 1,002,531, issued 5 Sep. 1911 to J. Levy, and U.S. Pat. No. 1,066,813, issued 8 Jul. 1913 to A. Heldrick, and U.S. Pat. No. 1,190,325, issued 11 Jul. 1916 to H. & I. Rosenthal, and U.S. Pat. No. 3,260,426, issued 12 Jul. 1966 to R. Ayotte, are examples. The use of internal springs to break up clots in dispensers is old with U.S. Pat. No. 2,110,252, issued 8 march 1938 to F. Wolcott, and 2,729,363, issued 3 Jan. 1956 to A. Bauer et al, and 4,598,844, issued 8 Jul. 1986 to W. Morris, teaching such use.

It has also been suggested that resilient elongated rods have one end vertically reciprocated to rotate an apertured member at the other end to dispense powder. In U.S. Pat. No. 2,998,166, issued 29 Aug. 1961 to W. Klawiter, rods longer than the height of the container are bent outwardly and radially with the upper end secured to a vertically reciprocated plunger and the lower end secured to imperforate sector elements that together cover about one-half of a base plate provided with passages. The plunger is free to move vertically but restrained from rotating. Pushing down on the plunger presses the upper extremes of the rods down and the mid-section of the rods against the container housing side walls, that restrict outward movement so as to rotate the lower ends of the rods and sector elements in the direction the rods are bent. Rotation of the imperforate sector elements uncovers the perforated sectors of the base plate to dispense granules. Stops limit the degree of rotation and the resilient deformation of the rods returns the plunger and sector elements when the plunger is released. Rotation of the sector elements removes and distributes granules from above the perforations in the base plate and rod movement dislodges particles from some areas of the side walls.

The use of helical springs in dispensers is common with both uniform diameter and increasing diameter coils well known. The springs are typically used for the application of linear or vertical pressure. The patents to G. Schwartzman, U.S. Pat. No. 3,256,551, issued 21 Jun. 1966, and U.S. Pat. No. 3,351,417, issued 7 Nov. 1967, and U.S. Pat. No. 3,570,396, issued 16 Mar. 1971, are examples. The patent to I. Humphreys, U.S. Pat. No. 1,710,480, issued 23 Apr. 1929, teaches a helical coil spring reciprocated to provide rotary motion.

The coil spring of the invention performs all of the discharge opening alinement and spring return of A. Heldrich and H.& I. Rosenthal; and the spring unclogging of A. Bauer et al; and distribution of W. Morris; and the conversion of top linear motion into lower rotary motion of W. Klawiter while also uniformly distributing particles over the entire base area of the dispenser.

### SUMMARY OF THE INVENTION

A lower closure wall and a movable slide plate are both provided with openings. The movable slide plate is secured to the lower extremes of helical springs that have their upper extremes attached to a vertically reciprocal plunger or boss precluded from rotating. Vertically pressing the boss inwardly causes the lower extreme of the helical spring to rotate the slide plate and to aline apertures in the slide plate with passages in the lower closure wall. Adjustable limit stops are provided to control rotation and opening size and shape of the passages determine granule amounts discharged and the distribution pattern. On release of the plunger, the tension within the spring returns the plunger upwardly and rotates the movable slide plate from alinement with passages in the lower closure wall to stop granule dispensing.

### BRIEF DESCRIPTION OF THE DRAWINGS

FIG. 1 is a perspective view of a prior art push plunger dispenser.

FIG. 2 is an exploded cross-sectional view of the basic dispenser components.

FIG. 3 is a partial perspective view of a movable apertured plate.

FIG. 4 is a partial perspective view of a lower closure wall.

FIG. 5 is a fragmentary sectional end view of an adjustable dispenser control.

FIG. 6 is a fragmentary sectional top view of the adjustable dispenser control of FIG. 5.

FIG. 7 is a fragmentary sectional top view of a modification of the adjustable dispenser control of FIGS. 5 & 6.

FIG. 8 is a cross-sectional fragmentary side view of the dispenser cap having the dispenser plunger assembled and incorporating an adjustable stop.

FIG. 9 is a top view of the dispenser with the cap removed and a depth control device in place.

FIG. 10 is a top view of the depth control device of FIG. 9.

FIG. 11 is a side view of the depth control device of FIG. 9.

FIG. 12 is a partial sectional view of the cap used with the depth control device of FIG. 9.

### DESCRIPTION OF THE PREFERRED EMBODIMENTS

The present dispenser is for discharging granules onto an object or into a substance. The “granules” can be salt, pepper, sugar, or other powder granular or pulverant materials.

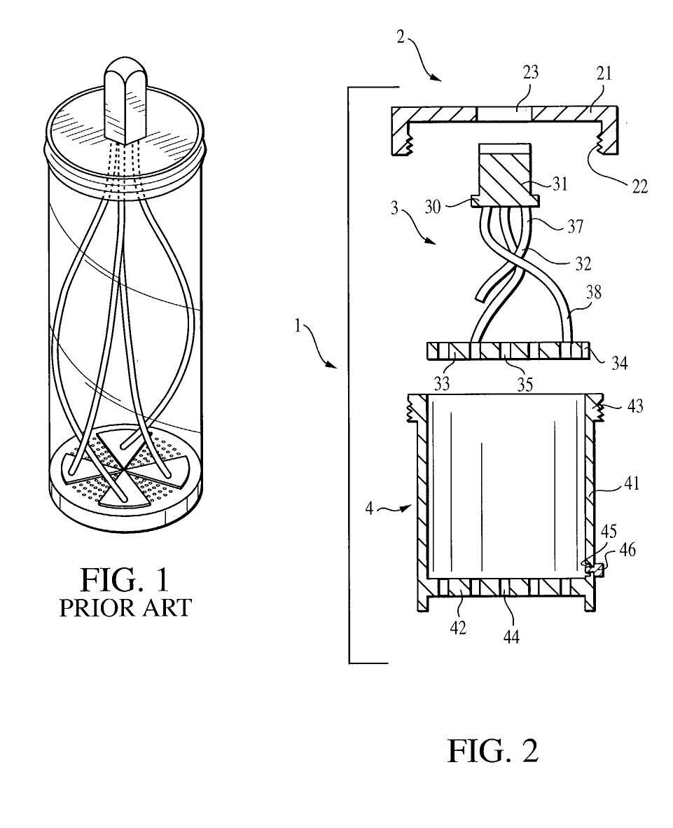

While the device can be made from any number of parts, the dispenser basic components are shown in an exploded view in FIG. 1. The particle dispenser 1 has a particle container 4 with side wall 41, lower closure wall 42 having open passages 44 and an open upper threaded end 43. A recess 45 can be provided in the lower side wall and adjustable slide 46 used to position a stop. A tab 34 on the movable plate can fit within the recess 45 in the side wall 41 and used to limit rotation of the movable plate. The dispensing mechanism 3 includes a plunger 31 attached to the upper end 37 of coil springs 32 having their lower ends 38 attached to a movable slide plate 33 having apertured passages 35. A cap 2 includes the container upper wall 21 provided with a shaped rotation preventing opening 23, in the shape of the non-circular plunger 31, and threads 22, that secure the cap onto the container 4. The assembled components are designed to place a small initial pressure on the spring as the plunger 31 passes through the shaped rotation preventing opening 23 in the cap and to place the passages in a non-alined position. The opening and plunger cross-section can be oval, square, or any other shape that will not permit rotation. When assembled, the movable plate 33 is pressed against the lower closure wall 42 and the plunger 31, positioned in the cap opening 23, is under slight pressure through the plunger flange 30. The plunger flange 30 limits upward movement of the plunger and prevents the escape of particles.

With granules placed in the container 4, after positioning the dispensing mechanism 3 in the container, and the cap 2 threaded or otherwise secured onto the container, the apertures in the movable apertured plate 33 and the passages 44 in the lower closure wall do not coincide or overlap and thus block particle dispensing. Pressing down on the plunger 31 places a vertical downward movement on the upper radially small diameter portion 37 of the coil spring 32. As the exerted force progresses down the spring from the small diameter to the lower radially larger diameter 38 of the springs 32, the irregular non-circular shape of the plunger and shaped rotation preventing opening 23 prevent rotation of the downwardly moving upper extreme of the coil spring. Since the lower large diameter end 38 of the coil spring is free to rotate, the vertical movement of the upper spring is converted into a rotary movement 39 at the lower extreme of the spring to rotate the movable apertured plate. Rotation of the movable apertured plate alines the apertures 35 of the movable apertured plate with the passages 44 of the lower closure wall to dispense particles through the alined passages. The diameter of the helical springs preferably increase uniformly in the radial direction from the upper to the lower extent of the springs.

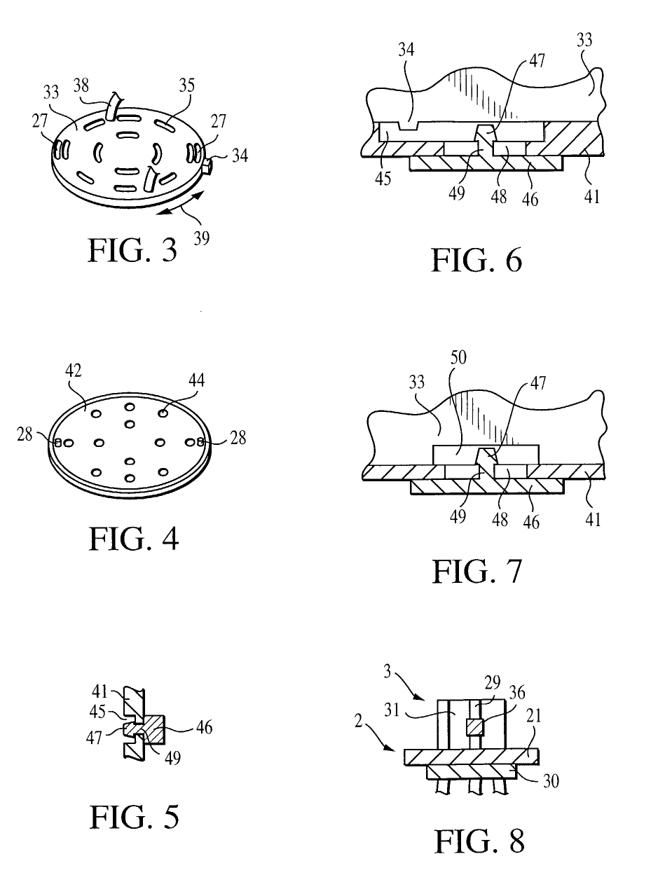

FIG. 3 depicts the movable apertured plate 33, showing the apertures 35 as being elongated, and FIG. 4 depicts the open passages 44 in the lower closure wall as being circular. The elongated apertures extend the time the particles within the dispenser are exposed to the passages in the lower closure wall and thus increases the amount of granule material dispensed. Limit pins 28 on the lower closure wall can extend into limit slots 27 in the movable apertured plate to limit the maximum degree of relative rotation between the movable apertured plate and the lower closure wall. By having the apertures 35 go past and beyond the passages 44, the discharge can be designed to dispense both when rotating due to the plunger being pressed down and also when the plunger is returned by spring pressure. Alternately, the discharge openings can be designed to be continuous as long as the plunger is depressed.

FIGS. 5 and 6 represent a manually slidable stop 47 that can be used for adjusting the distance the elongated aperture slots 35 on the movable apertured plate 33 can be rotated past the open passages 44 of the lower closure wall 42 as the movable apertured plate 33 oscillates. The adjustable stop 47 is attached to an adjustment slide 46 that covers an adjustment slot 48 to prevent leakage. The stop stem 49 and stop 47 can be elastic or plastic to frictionally engage the side wall 41 at the adjustment slot. By using a tab 34 on the movable apertured plate 33 placed within a recess 45 in the side wall 41, the adjustment stop 47 can be positioned to abut the tab and limit rotation of the movable apertured plate and consequently the amount of granular discharge. Since the spring is resilient, excess depression of the plunger can be absorbed by distortion of the resilient spring.

FIG. 7 represents another alternate system for adjusting and controlling the amount of granules dispensed. It is a modification of the manual slide stop shown in FIGS. 5 and 6. Rather than using a tab on the movable apertured plate 33, a peripheral slot 50 is provided in the outer extreme of the movable apertured plate 33. The adjustable stop 47 passes through the side wall 41 through the adjustment slot 48 with the stop stem 49 projecting into the adjustment slot 48 and into the peripheral slot 50 in the movable apertured plate 33. The adjustment slot 48 is covered by the adjustment slide 46 to prevent leakage and provide a means for moving the stop 47 and stem 49 to overcome the frictional resistance they have with the side wall 41.

FIG. 8 represents an alternate system for adjusting and controlling the amount of granules dispensed. To control the time or distance the elongated slots 35 are over the passages 44 of the lower closure wall, the distance the plunger can be depressed is controlled. Since the amount of rotation of the movable apertured plate depends on the amount or degree the helical coil spring upper end is depressed, controlling the depression distance of the plunger will also control the amount of particles dispensed. An abutting stopper 36 is shown frictionally secured in an adjustment slot 29 in the plunger 31 of the dispensing mechanism 3. The abutting stopper 36 can be positioned within the slot 29, or forced along it, to adjust the distance between the abutting stopper 36 and the top surface of the cap 2 upper wall 21. This distance determines the amount the plunger flange 30 and upper coil 37 can be moved vertically downward and thus the amount of rotations of the movable apertured plate 33.

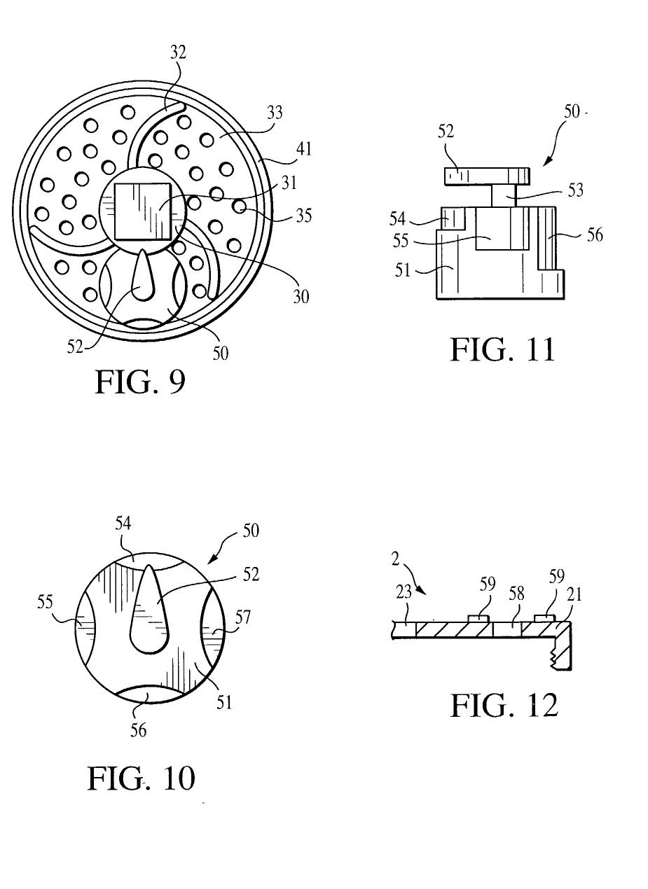

FIGS. 9-12 illustrate a plunger 31 depth control device 50. To adjust and selectively limit the depth to which the plunger can be pushed into the dispenser 1, a cylindrical depth control device 50 is secured to the cap 2. A shaft 53 passes through a bearing opening 58 in the cap and is secured in place by depth selection dial 52 secured to the shaft above the cap. The cylinder 51 on the shaft 53 is positioned below the plunger flange 30. As can be seen in FIG. 9, the cylinder 51 and plunger flange 30 have an overlap. The cylinder 51 is provided with arcuate recesses 54-57 that extend down into the cylinder to different depths. By alining the arcuate recesses with the flange 30, pressing on the plunger 31 permits the flange and plunger to go into the dispenser until the flange contacts the base of the alined arcuate recess. Since the arcuate recesses have different depths within the cylinder 51, by selecting the appropriate arcuate recess to mate with the flange, the plunger maximum depth can be manually selected. The cap 21 can be provided with indicia 59 to aline the selection dial 52 with a specific arcuate recess to indicate the depth at which the depth control device has been set.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. A solid particle dispenser comprising:
a particle container having an upper closure wall, side closure wall, and a lower closure wall;
said upper closure wall having a shaped rotation preventing opening;
said lower closure wall having a plurality of open passages essentially uniformly spaced therethrough;
a helical coil spring having an upper extent and a lower extent within said dispenser;
a shaped plunger for passing through said shaped rotation preventing opening;
said upper extent of said helical spring is secured to said shaped plunger that passes through said upper closure wall shaped rotation preventing opening;
a movable plate extending over said lower closure wall with apertures essentially uniformly spaced therethrough;
said lower extent of said helical coil spring is secured to said movable apertured plate such that pressing said shaped plunger inwardly rotates said movable apertured plate to aline said movable apertured plate apertures with said lower closure wall open passages for essentially uniformly dispensing particles.

2. A solid particle dispenser as in claim 1 wherein:
aid upper extent of said helical coil spring has a smaller radial diameter than said lower extent of said helical coil spring such that pressing on said plunger moves said upper extent of said helical coil spring vertically to rotate said lower extent of said helical coil spring within said dispenser.

3. A solid particle dispenser as in claim 2 wherein:
said helical coil spring coils uniformly increase in radial diameter from said upper extent to said lower extent of said helical coil spring.

4. A solid particle dispenser as in claim 1 wherein:
said movable apertured plate apertures are elongated to increase the distance said lower closure wall open passages are exposed to particles within said dispenser as said movable apertured plate is rotated.

5. A solid particle dispenser as in claim 4 wherein:
said movable apertured plate elongated open apertures and said lower closure wall open passages are positioned to be alined and dispense particles both when said plunger is depressed and when said plunger is raised by return pressure from said helical coil spring, to dispense particles on both forward and return rotation of said movable apertured plate.

6. A solid particle dispenser as in claim 1 wherein:
said dispenser having means to limit rotation of said movable apertured plate.

7. A solid particle dispenser as in claim 6 wherein:
said means to limit movement of said movable apertured plate is a limit stop on said lower closure wall that extends into a limit slot in said movable apetured plate.

8. A solid particle dispenser as in claim 6 wherein:
said means to limit movement of said movable apertured plate is a tab on said movable apertured plate that abuts against an adjustable stop in a recess associated with said side closure wall.

9. A solid particle dispenser as in claim 8 wherein:
said adjustable stop projects through an adjustment slot in said side closure wall.

10. A solid particle dispenser as in claim 9 wherein:
said adjustable stop is attached to a stop stem on an adjustment slide.

11. A solid particle dispenser as in claim 6 wherein:
said means to limit rotation of said movable apertured plate has an adjustable stop associated with said side closure wall;
a peripheral slot is in said movable apertured plate;
said adjustable stop protrudes into said peripheral slot to limit movement of said movable apertured plate.

12. A solid particle dispenser as in claim 11 wherein:
said adjustable stop is attached to an adjustment slide by a stop stem;
an adjustment slot is provided in said side closure wall for passage of said stop stem.
said adjustable stop and said stop stem extend through said adjustment slot and frictionally hold said adjustable stop in said side closure wall.

13. A solid particle dispenser as in claim 6 wherein:
said means to limit movement of said movable apertured plate is an adjustable abutting stopper on said shaped plunger.

14. A solid particle dispenser as in claim 13 wherein:
said shaped plunger has a longitudinal slot facing outwardly;
said abutting stopper is adjusted by frictionally sliding said abutting stopper within said longitudinal slot in said shaped plunger.

15. A solid particle dispenser as in claim 6 including:
a plunger flange below and attached to said shaped plunger to limit movement of said shaped plunger.

16. A solid particle dispenser as in claim 15 wherein:
said means to limit movement of said movable apertured plate is a cylinder positioned under said plunger flange.

17. A solid particle dispenser as in claim 16 wherein:
said cylinder is provided with different depth recesses to adjust the distance said shaped plunger can be depressed into said dispenser.

18. A solid particle dispenser as in claim 17 wherein:
said cylinder is rotatable to selectively place different depth recesses under said plunger flange.

19. A solid particle dispenser as in claim 18 including:
a depth selection dial attached to said cylinder for rotating said cylinder;
indicia on said upper closure wall for alinement with said depth selection dial to indicate said recessed depth of said selected recess.
